(19) United States
(12) Patent Application Publication
(10) Pub. No.: US 2019/0219818 A1
(43) Pub. Date: Jul. 18, 2019

(54) EYE TRACKING FOR AUGMENTED REALITY AND VIRTUAL REALITY

(71) Applicant: Tobii AB, Danderyd (SE)

(72) Inventor: Fredrik Mattinson, Danderyd (SE)

(73) Assignee: Tobii AB, Danderyd (SE)

(21) Appl. No.: 16/250,105

(22) Filed: Jan. 17, 2019

Related U.S. Application Data
(60) Provisional application No. 62/618,596, filed on Jan. 17, 2018.

(51) Int. Cl. G02B 27/00; G02B 27/01; G02B 27/28; G06F 3/01

(52) U.S. Cl. CPC G02B 27/0093; G02B 27/0179; G02B 2027/0187; G02B 27/286; G06F 3/013; G02B 27/283

(57) ABSTRACT

A display system may include a display, a beam splitter, a mirror, and an eye tracking system. The beam splitter may receive display light from the display in a first direction and direct at least some of the display light towards the mirror. The mirror may reflect at least some of the display light from the beam splitter back towards the beam splitter, where the beam splitter may direct at least some of the reflected display light in a second direction. The eye tracking system may comprise a light source for providing tracking light for reflection at an eye. The beam splitter may receive reflected tracking light back from the second direction and direct at least some of that light towards the eye tracking system. The eye tracking system may comprise a camera for receiving at least some of the reflected tracking light directed by the beam splitter.

### CROSS-REFERENCE TO RELATED APPLICATIONS

This application claims the benefit of Provisional U.S. Patent Application No. 62/618,596, filed Jan. 17, 2018, the disclosure of which is incorporated herein by reference in its entirety.

### BACKGROUND

Devices such as head mounted displays (HMD) may be employed to display images on a display panel in front of the eyes of a user. The HMD may be employed to convey a virtual reality (VR) experience. Some HMD may employ a semitransparent display to convey an augmented reality (AR) experience by allowing the user to see the environment overlaid by an image displayed at a display panel. Other devices such as head up displays (HUD) in trucks, cars, and aircraft may also be equipped with AR functionality.

### SUMMARY

Examples are described for providing a display system comprising a display (e.g., a screen), a beam splitter, a mirror, and an eye tracking system. The display is arranged to display an image. The display may, for example, comprise a display panel or a surface at which the image is projected. The eye tracking system comprises a camera. The beam splitter and the mirror may be employed to direct light from the display towards an eye, and/or to direct reflected light from the eye towards the camera. The display, the beam splitter, the mirror, the eye tracking system, and/or further components (e.g., such as one or more lenses and/or one or more additional mirrors) may be arranged (e.g., positioned and/or oriented) relative to each other to allow the eye to see the display while the camera may capture images of the eye for use in eye tracking.

It will be appreciated that light received by the beam splitter may for example be directed by the beam splitter by being reflected by the beam splitter, or by being transmitted by the beam splitter (e.g., the light may be allowed to pass through the beam splitter in substantially the same direction as it was received by the beam splitter). Light which is directed by the beam splitter may not necessarily be redirected by the beam splitter. That the beam splitter is arranged to “direct” light in a certain direction may alternatively be referred to as that the beam splitter is arranged to “output” light in that direction.

The display, the beam splitter, the mirror, and the eye tracking system may for example be arranged such that light from the display may be reflected by the beam splitter, may then be reflected by the mirror back towards the beam splitter, and may then be transmitted through the beam splitter before reaching the eye, and such that light from the eye (e.g., light which has been reflected at the eye) may be reflected by the beam splitter towards the camera of the eye tracking system.

The display, the beam splitter, the mirror, and the eye tracking system may for example be arranged such that light from the display may be transmitted through the beam splitter, may then be reflected by the mirror back towards the beam splitter, and may then be reflected by the beam splitter before reaching the eye, and such that light from the eye (e.g., light which has been reflected at the eye) may be transmitted through the beam splitter towards the camera of the eye tracking system.

The beam splitter may be arranged to receive display light from the display in a first direction (e.g., along a first axis). The beam splitter may be arranged to direct at least some of the display light from the display towards the mirror. The mirror may be arranged to reflect at least some of the display light from the beam splitter back towards the beam splitter. The beam splitter may be arranged to receive at least some of the reflected display light from the mirror. The beam splitter may be arranged to direct at least some of the reflected display light from the mirror in a second direction (e.g., along a second axis). The eye tracking system may comprise a light source arranged to provide tracking light for reflection at an eye. The beam splitter may be arranged to receive reflected tracking light back from the second direction (e.g., back along the second axis). The beam splitter may be arranged to direct at least some of the received reflected tracking light along an optical path towards the eye tracking system. The eye tracking system may comprise a camera arranged to receive at least some of the received reflected tracking light directed by the beam splitter.

The second direction (e.g., the second axis) may for example be transverse to the first direction (e.g., the first axis), or orthogonal to the first direction (e.g., the first axis).

The beam splitter may be a polarizing beam splitter. The display system may further comprise a polarization-modifying element arranged between the beam splitter and the mirror. The polarization-modifying element may for example be arranged to alter a polarization state of display light travelling from the beam splitter to the mirror and back to the beam splitter.

The polarization state may for example be altered by the polarization-modifying element from a first linear polarization (e.g., which may be the polarization state of the display light when exiting the beam splitter towards the mirror) into a second linear polarization (e.g., which may be the polarization state of the display light when reaching the beam splitter after having travelled back and forth to the mirror).

The polarizing beam splitter may for example be arranged to reflect light of a first polarization and to transmit light of a second polarization. Using suitable polarizations for the display light and the tracking light may for example allow the beam splitter to treat the display light in a first manner and the tracking light in a second manner. The first manner may be different than the second manner (e.g., the display light may be treated differently than the tracking light). Use of a polarizing beam splitter may for example allow the display light and/or the tracking light to be employed more efficiently by the display system than if for example a 50/50 beam splitter (transmitting 50 percent if incident light and reflecting 50 percent of incident light) were to be employed.

The polarization-modifying element may for example allow light which has been reflected by the beam splitter towards the mirror to be transmitted by the beam splitter when it returns to the beam splitter from the mirror, or may allow light which has been transmitted by the beam splitter towards the mirror to be reflected by the beam splitter when returning to the beam splitter from the mirror.

According to some examples, the polarization-modifying element may be a quarter wave-plate (e.g., which may also referred to as a ¼ wave plate).

According to some examples, the display may be arranged to display the image using polarized display light, or the display system may comprise a first polarizing element arranged to polarize display light from the display before the display light from the display is received by the beam splitter.

According to some examples, the light source may be arranged to output polarized tracking light, or the display system may comprise a second polarizing element arranged to polarize tracking light from the light source before the tracking light from the light source is received by the beam splitter.

The tracking light may for example be polarized in accordance with the same polarization state as the display light. The second polarizing element may for example be arranged to polarize tracking light before the tracking light is reflected at the eye, or after the tracking light has been reflected at the eye.

According to some examples, the beam splitter may be arranged to receive tracking light from the eye tracking system and to direct at least some of the tracking light from the eye tracking system in the second direction (e.g., along the second axis). The tracking light may be directed by the beam splitter before being reflected at the eye and after being reflected at the eye.

According to some examples, the eye tracking system may be arranged to provide the tracking light such that it is received by the beam splitter along a certain axis. The camera may be arranged to receive light directed by the beam splitter back along the certain axis.

According to some examples, the beam splitter may be arranged to direct the at least some of the display light from the display towards the mirror by reflecting display light from the display. The beam splitter may be arranged to direct the at least some of the reflected display light from the mirror in the second direction (e.g., along the second axis) by transmitting reflected display light from the mirror. The beam splitter may be arranged to direct the at least some of the received reflected tracking light by reflecting at least some of the received reflected tracking light.

Display light from the display may be reflected by the beam splitter towards the mirror, may then be reflected by the mirror back towards the beam splitter, and may then be transmitted through the beam splitter before reaching the eye. Tracking light reflected at the eye may be reflected by the beam splitter along an optical path towards the camera of the eye tracking system.

According to some examples, the mirror may be semitransparent and arranged to allow at least some light from outside the display system to pass through the mirror towards the beam splitter. The display system may for example provide an augmented reality (AR) view by providing the eye with a combination of the display light and the light from outside the display system.

According to some examples, the beam splitter may be arranged to receive tracking light from the eye tracking system and to direct at least some of the tracking light from the eye tracking system in the second direction (e.g., along the second axis) by reflecting tracking light from the eye tracking system.

According to some examples, the display system may comprise a spectrally selective filter arranged between the eye tracking system (e.g., the camera of the eye tracking system) and the beam splitter. The spectrally selective filter may be arranged to prevent display light from the display to reach the camera.

The tracking light may for example be provided in a different frequency range than the display light. The tracking light may for example be provided in the infrared range or the near infrared range, while the display light may for example be provided in the visible range. The spectrally selective filter may for example be a low pass filter or a band pass filter for allowing the tracking light to pass through the filter to the camera.

According to some examples, the beam splitter may be spectrally selective (e.g., frequency-dependent). The beam splitter may treat light from different frequency ranges in different ways.

According to some examples, the beam splitter may be arranged to act as a reflector for light in a first frequency range (e.g., such as the infrared or near infrared frequency range). The beam splitter may be arranged to split light in a second frequency range (e.g., such as the visible frequency range) into at least a transmitted portion and a reflected portion. The beam splitter may for example comprise a hot mirror.

According to some examples, the beam splitter may be arranged to direct the at least some of the display light from the display towards the mirror by transmitting display light from the display. The beam splitter may be arranged to direct the at least some of the reflected display light from the mirror in the second direction by reflecting reflected display light from the mirror. The beam splitter may be arranged to direct the at least some of the received reflected tracking light by transmitting at least some of the received reflected tracking light.

Display light from the display may be transmitted through the beam splitter, may then be reflected by the mirror back towards the beam splitter, and may then be reflected by the beam splitter before reaching the eye. Tracking light which has been reflected in the eye may be transmitted through the beam splitter along an optical path towards the camera of the eye tracking system.

According to some examples, the display system may comprise a second mirror. The camera may be arranged to receive, via reflection in the second mirror, at least some of the received reflected tracking light directed by the beam splitter. Received reflected tracking light which has been directed by the beam splitter may be reflected in the second mirror before reaching the camera.

The second mirror may redirect light from the beam splitter and may for example allow the camera to be arranged at a different location than without use of the second mirror.

According to some examples, the second mirror may be semitransparent and arranged to allow at least some light from outside the display system to pass through the second mirror towards the beam splitter. The display system may for example provide an augmented reality (AR) view by providing the eye with a combination of the display light and the light from outside the display system.

According to some examples, the second mirror may be arranged to transmit light in the visual range and to reflect light in the infrared or near infrared range. The second mirror may for example be a so-called hot mirror.

The tracking light may for example be provided in the infrared range or the near infrared range, while the display light may for example be provided in the visible range. The second mirror may therefore reflect tracking light, while visible light from the surroundings and/or from the display may pass through the second mirror.

According to some examples, the beam splitter may be arranged to receive tracking light from the eye tracking system and to direct at least some of the tracking light from the eye tracking system in the second direction (e.g., along the second axis) by transmitting tracking light from the eye tracking system. The beam splitter may be arranged to allow at least some tracking light from the eye tracking system to pass through the beam splitter.

According to some examples, the display system may comprise a second mirror. The beam splitter may be arranged to receive tracking light from the eye tracking system via reflection in the second mirror. Tracking light from the eye tracking system may be reflected in the second mirror before reaching the beam splitter.

The second mirror may redirect light from the light source of the eye tracking system and may for example allow the light source to be arranged at a different location than without use of the second mirror.

According to some examples, the display system may comprise a light guiding optical element (e.g., a waveguide) arranged to receive light directed by the beam splitter in the second direction (e.g., along the second axis). The light guiding optical element may be arranged to guide at least some light from the beam splitter towards the eye. The light guiding optical element may be arranged to guide at least some light reflected at the eye towards the beam splitter. The light guiding optical element may be arranged to guide light back and forth between the beam splitter and the eye.

The light guiding optical element may for example allow the beam splitter, the mirror, and/or the eye tracking system to be arranged at a different location than in front of the eye.

According to some examples, the display system may comprise one or more optical elements arranged between the display and the beam splitter for correcting aberrations.

According to some examples, the one or more optical elements may include a triplet.

According to some examples, the mirror may be concave. The concave shape may allow the mirror to gather display light from the display (e.g., after the display light has been directed by the beam splitter). The mirror may for example be a bird bath mirror.

According to some examples, the mirror may be a spherical mirror or an aspherical mirror. The mirror may for example be a parabolic mirror. Spherical mirrors may for example be easier (or cheaper) to manufacture, while aspherical mirrors (such as parabolic mirrors) may for example be associated with less aberration.

According to some examples, the light source of the eye racking system may be arranged to output tracking light in the infrared range (for example with a wavelength in the range 700 nm-1000 nm, or 800 nm-1000 nm) or the near infrared range (for example with a wavelength in the range 750 nm-1400 nm).

According to some examples, the display system may be comprised in a head mounted device, HMD. According to some examples, the display system may be comprised in a head up display, HUD.

It is noted that examples described herein may relate to all possible combinations of features recited in the claims.

### BRIEF DESCRIPTION OF THE DRAWINGS

In what follows, examples will be described in greater detail and with reference to the accompanying drawings, on which:

FIG. 1 shows an example augmented reality (AR) display system where display light from a display reaches an eye via reflection in a beam splitter followed by reflection in a mirror and then transmission through the beam splitter, while eye tracking is performed via reflection of eye tracking light in the beam splitter;

FIG. 2 shows example light paths for display light from the display in the example display system from FIG. 1;

FIG. 3 shows an example AR display system including the example display system from FIG. 1, but provided with a light guiding optical element;

FIG. 4 shows an example of the AR display system from FIG. 3, but with light guiding optical elements for the left and right eyes;

FIG. 5 shows an example AR display system similar to the display system in FIG. 4, but where light sources for the eye tracking are provided along the edge of the light guiding optical elements;

FIG. 6 shows an AR display system similar to the display system in FIG. 1, but using a polarizing beam splitter;

FIG. 7 shows an AR display system where display light from a display reaches an eye via transmission through a beam splitter followed by reflection in a mirror and then reflection in the beam splitter, while eye tracking is performed via transmission of eye tracking light through the beam splitter;

FIG. 8 shows an AR display system similar to the display system in FIG. 7, but using a polarizing beam splitter;

FIG. 9 shows an example virtual reality (VR) display system with eye tracking;

FIG. 10 shows an example display system similar to the display system in FIG. 1, but adapted for VR;

FIG. 11 shows an example AR display system including the display system from FIG. 6, but provided with a light guiding optical element;

FIG. 12 shows an example AR display system including the display system from FIG. 7, but provided with a light guiding optical element; and

FIG. 13 shows an example AR display system including the display system from FIG. 8, but provided with a light guiding optical element.

All the figures are schematic, not necessarily to scale, and may only show parts of the examples.

### DETAILED DESCRIPTION

A detailed description of illustrative examples will now be described with reference to the various Figures. Although this description provides a detailed example of possible implementations, it should be noted that the details are intended to be exemplary and in no way limit the scope of the application.

AR and/or VR devices may be equipped with eye tracking (often also referred to as gaze tracking), wherein a gaze direction and/or gaze point of the eye is monitored to allow a user to control various functions via movement of the eyes. Light sources are often employed to illuminate the eyes of the user, and cameras are employed to capture images of the eyes. The images are subjected to image processing for detecting features of the eyes such as pupils and glints from the light sources. A gaze direction and/or gaze point is then computed based on the positions of the detected features in the images.

Aspects of designing eye tracking solutions for AR and VR devices may include arranging the eye tracking equipment (for example including cameras and light sources) in a way that does not obscure or limit the field of view (FOV) of the user, while still providing sufficiently reliable and accurate eye tracking performance. Aspects of designing eye tracking solutions for AR and/or VR devices (e.g., for portable devices such as HMD) may include keeping the size and/or weight of a device down when the device is equipped with eye tracking. Aspects of designing eye tracking solutions for AR and/or VR devices may include keeping energy consumption low and/or being able to perform the eye tracking with the limited processing resources that can fit within the limited space available.

Examples of HMDs may be found in document US 2017/0147859 A1 (which is incorporated herein by reference in its entirety). A HMD may comprise a display panel, an x-prism beam splitter, and a camera. The x-prism beam splitter directs light from the display panel into an eye of the user. Light which has been reflected in the eye is directed by the x-prism beam splitter into the camera for eye tracking. HMDs may be employed to provide a VR experience.

Eye tracking may be provided in the context of virtual reality and/or augmented reality.

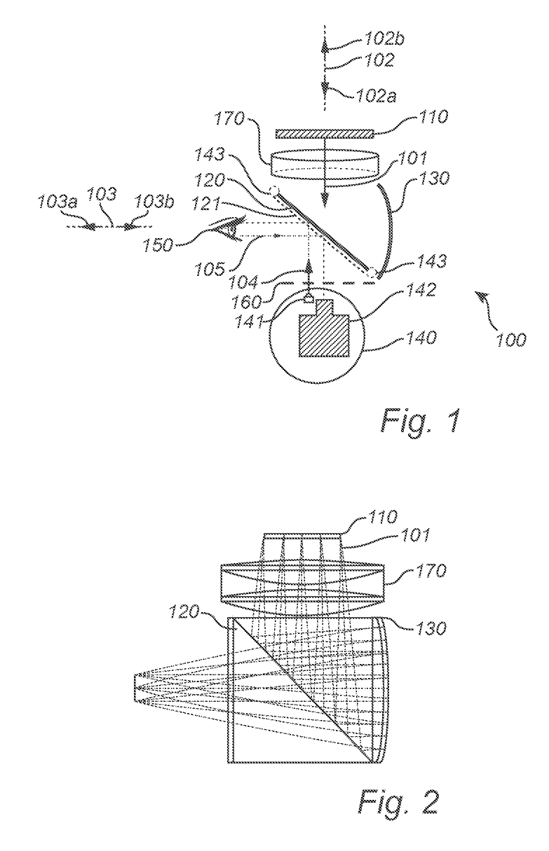

FIG. 1 shows a display system 100 according to an example. The display system 100 comprises a display 110, a beam splitter 120, a mirror 130, and an eye tracking system 140. The display 110 is arranged to display an image. As described below, the display system 100 may be employed to covey and augmented reality (AR) experience to an eye 150, and may therefore be referred to as an AR display system 100. The display system 100 may for example be part of a head mounted display (HMD) or a head up display (HUD).

The beam splitter 120 is 50/50 beam splitter that transmits 50 percent of the incoming light and reflects 50 percent of the incoming light. In other words, the beam splitter 120 is of a type that allows half of the incoming light to pass through the beam splitter 120 while the other half of the incoming light is reflected. The mirror 130 is semitransparent and allows half of incoming (e.g., incident) light to pass through the mirror 130, while the other half of the incoming light is reflected by the mirror 130. The mirror 130 may therefore also be regarded as a beam splitter.

The beam splitter 120 is arranged to receive display light 101 from the display 110 in a direction 102a along a first axis 102 (see also FIG. 2) and to direct (e.g., output) half of the display light 101 towards the mirror 130 by reflecting half of the display light 101. The mirror 130 is arranged to reflect half of the display light from the beam splitter 120 back towards the beam splitter 120. The beam splitter 120 is arranged to receive reflected display light from the mirror 130 and to direct (e.g., output) half of the reflected display light from the mirror 130 in a direction 103a along a second axis 103 by transmitting half of the reflected display light from the mirror 130.

The eye tracking system 140 comprises a light source 141 arranged to provide tracking light 104 for reflection at an eye 150. The beam splitter 120 is arranged to receive reflected tracking light 105 in a direction 103b back along the second axis 103, and to direct (e.g., output) half of the received reflected tracking light 105 along an optical path towards the eye tracking system 140 by reflecting half of the received reflected tracking light 105. The eye tracking system 140 comprises a camera 142 arranged to receive the received reflected tracking light directed by the beam splitter 120.

The light source 141 of the eye tracking system 140 is arranged together with the camera 142 in an eye tracking module located at an opposite side of the beam splitter 120 compared to the display 110. The eye tracking system 140 is arranged to provide the tracking light 104 such that it is received by the beam splitter 120 in a direction 102b along the first axis 102 which is opposite to the direction 102a in which the display light 101 from the display 110 is received by the beam splitter 120. The beam splitter 120 is arranged to receive tracking light 104 from the eye tracking system 140 and to direct (e.g., output) half of the tracking light 104 from the eye tracking system 140 in a direction 103a along the second axis 103. The camera 142 is arranged to receive reflected tracking light directed by the beam splitter 120 in a direction 102a back along the first axis 102.

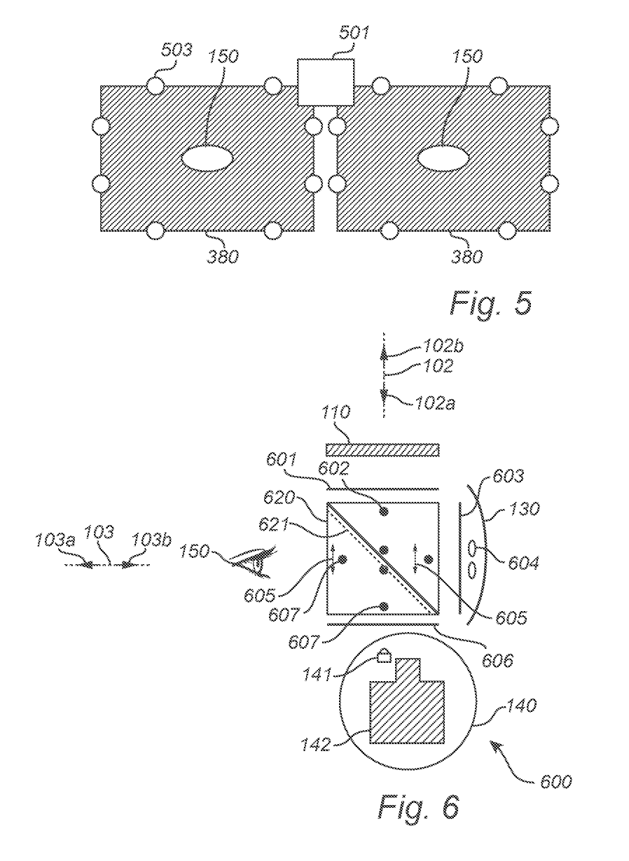

As described below with reference to FIG. 5, examples provided herein may also be envisaged in which the light source 141 is not co-located with the camera 142. Examples may also be envisaged in which eye tracking without active eye illumination is employed. Examples may be envisaged in which there are no separate light sources 141 for providing tracking light 104, and where the eye tracking utilizes light from the display 110 and/or light from the environment to illuminate the eye 150.

The mirror 130 is concave to gather light from the display 110, and the display 110 is positioned at the focus of the mirror 130 to achieve a virtual image. Since the mirror 130 is semitransparent, light from outside the display system 100 passes through the mirror 130 towards the beam splitter 120. The eye 150 can therefore see an augmented reality (AR) view of the surroundings where the image displayed by the display 110 is overlaid onto the surroundings. The beam splitter 120 therefore acts as a combiner that projects the virtual image of the display 110 on the surrounding environment. FIG. 1 shows the example display system 100 from the side such that the eye 150 of the user is looking towards the right and sees the surroundings through the beam splitter 120 and the mirror 130.

Since a 50/50 beam splitter 120 and a 50/50 semitransparent mirror 130 (which may also be regarded as a beam splitter) are employed, some light from the display 110, the light source 141 and the surroundings does not reach the eye 150, and some light reflected at the eye 150 does not reach the camera 142.

Light from the surroundings reaches the eye 150 via transmission through the mirror 130 and the beam splitter 120. Half of the light from the surroundings is therefore lost due to reflection in the mirror 130, and half of the remaining light is lost due to reflection in the beam splitter 120. Hence, about 25 percent of the available light from the surroundings may reach the eye 150.

Display light 101 from the display 110 reaches the eye 150 via reflection in the beam splitter 120, followed by reflection in the mirror 130, and then transmission through the beam splitter 120. Half of the display light 101 is therefore lost due to transmission through the beam splitter 120, half of the remaining display light is lost due to transmission through the mirror 130, and half of the remaining display light is lost due to reflection in the beam splitter 120. Hence, about 12.5 percent of the available display light 101 from the display 110 may reach the eye 150.

Tracking light 104 from the light source 141 reaches the eye 150 via reflection in the beam splitter 120, and tracking light 105 reflected at the eye 150 reaches the camera 142 via reflection in the beam splitter 120. Half of the tracking light 104 is therefore lost due to transmission through the beam splitter 120, and about half of the reflected tracking light 105 is lost due to transmission through the beam splitter 120. Hence, about 25 percent of the available tracking light 104 may reach back to the camera 142. Since all light is typically not reflected back from the eye, less than 25 percent of the tracking light 104 from the light source 141 may reach the camera 142.

Examples may also be envisaged in which the proportion of light transmitted and reflected by the beam splitter 120 and/or the mirror 130 is different than 50/50. The proportion of light transmitted and reflected by the beam splitter 120 may be any number including 10/90, 20/80, 30/70, 40/60, 50/50, 60/40, 70/30, 80/20, or 90/10. The proportion of light transmitted and reflected by the mirror 130 may be any number including 10/90, 20/80, 30/70, 40/60, 50/50, 60/40, 70/30, 80/20, or 90/10.

If it is desirable to increase the amount of light from the surroundings (for example during the evening when it is dark), the mirror 130 may for example be adapted to transmit 60, 70, 80 or even 90 percent of the incoming light, while reflecting the rest of the incoming light. This increases the light intensity from the surroundings at the cost of higher loss of display light 101. The opposite effect may for example be achieved by selecting a mirror 130 which is adapted to transmit as little as 40, 30, 20, or even 10 percent of the incoming light, while reflecting the rest of the incoming light.

Examples may also be envisaged in which the beam splitter 120 is frequency-selective. For example, the tracking light 104 from the light source 141 may be outside the visible range (for example in the infrared or near infrared range), while the display light 101 from the display 110 and the desired light from the surroundings is in the visible range. The beam splitter 120 may for example be a 50/50 beam splitter for visible light, but may be a reflector (e.g., a total reflector) for lower frequency light (such as infrared or near infrared light). This would allow up to 100 percent of the available tracking light to reach the camera 142 (e.g., some tracking light may be lost due to imperfect reflection at the eye 150). Such a frequency-selective beam splitter may for example be obtained by using an ordinary 50/50 beam splitter 120 combined with a hot mirror 121 (such as a reflector with a band pass filter that transmits light in the range 400 nm-700 nm and reflects light in the rage 800 nm-1000 nm) at the side of the beam splitter 120 facing away from the display 110 (e.g., at the side at which received reflected tracking light from the eye 150 is output by the beam splitter 120 along the optical path towards the camera 142 of the eye tracking system 140).

The beam splitter 120 may for example be a cube beam splitter comprising two triangular glass prisms clued together using a resin. The beam splitter 120 may for example comprise a sheet of glass or plastic material with a suitable coating, such an aluminum coating.

The concave mirror 130 may be referred to as a bird bath mirror. The mirror 130 may for example be spherical since such mirrors are relatively easy to manufacture. However, the mirror 130 may be aspherical to mitigate the potential problem of aberrations. The mirror 130 may for example be parabolic.

The display 110 may be arranged at the focal position (or focal distance) of the mirror 130, such that the image displayed at the display 110 is perceived by the eye as being located at infinity. However, examples may also be envisaged in which the display 110 is arranged at a different distance from the mirror 130 than the focal distance of the mirror 130, for obtaining other optical effects. The size of the display 110 and the focal length (or the radius) of the mirror 130 affect the field of view (FOV) of the display system 100. The combination of the concave mirror 130 and the beam splitter 120 may allow for a relatively large FOV even if a relatively small display 110 is employed. Glass may for example be provided along the optical path between the display 110 and the mirror 130 such that the geometric size of the display system 100 may be decreased while maintaining a large FOV.

The display 110 may for example be a micro display. The display 110 may for example be an LCD display, an emissive OLED display, or a reflective LCoS display with illumination. The display 110 may for example be a display panel, or a surface for displaying a projected image. The display 110 may for example be a diffuser for use with projector optics. The display 110 may for example be a retinal projection display. Lasers and a MEMS mirror may for example be employed to draw an image at an exit pupil expander (EPE) to increase the size of an exit pupil, and the display 110 can be seen as the EPE, since it is where the intermediate image plane will be located.

A spectrally selective filter 160 may be arranged between the eye tracking system 140 and the beam splitter 120 for preventing display light from the display 110 to reach the camera 142. If invisible light (such as infrared light or near infrared light) is employed by the eye tracking system 140, the filter 160 may be arranged to allow such invisible light to pass, while preventing light from the visible frequency range to reach the camera 142. The filter 160 may for example reduce interference at the camera caused by light from the display 110 and/or from the surroundings of the display system 100.

The display system 100 may for example be provided with further optical elements. A triplet 170 may for example be arranged between the display 110 and the beam splitter 120 for correcting aberrations.

The light source 141 may for example be a solid state light source such as a light emitting diode (LED) or a vertical-cavity surface-emitting laser (VCSEL). The light source 141 may be arranged to emit light outside the visible spectrum (such as infrared or near infrared light), but examples may also be envisaged in which the light source 141 emits light visible to humans.

The camera 142 may for example be located substantially coaxially with the light source 141 for capturing bright pupil images of the eye 150, or may be arranged off axis relative to the light source 141 for capturing dark pupil images of the eye 150. The light source 141 may for example be arranged together with the camera 142 in an eye tracking module.

The eye tracking system 140 may for example comprise a single light source 141, or multiple light sources. Examples may also be envisaged in which the eye tracking system 140 utilizes light from the display 110 or from the surroundings to illuminate the eye 150 (e.g., the eye tracking system may not include light sources for illuminating eye).

The camera 142 may for example be a CMOS (Complementary Metal Oxide Semiconductor) camera, or a CCD (charged coupled device) camera. Examples may also be envisaged in which the eye tracking system 140 comprises multiple cameras. The camera 142 captures images straight into eye 150 (e.g., from a forward direction of the eye 150), which may improve the chances of detecting features of the eye 150 such as the pupil and/or a glint from the light source 141 (compared to a setup where images are captured from the side of the eye 150 at an angle relative to the forward direction of the eye 150). The display system 100 is an on-axis system where the camera 142 is arranged at the same optical axis as the eye 150.

The eye tracking system 140 may for example employ image processing (such as digital image processing) for detecting and/or tracking features of the eye 150 in the images captured by the camera 142. The detected features of the eye 150 may for example include a pupil of the eye 150 and/or a glint at the eye 150 caused by reflection of tracking light 104 from the light source 141 at the eye 150. Based on such features, a gaze direction or gaze point of the eye 150 may be determined (e.g., computed, or estimated). The gaze tracking system 140 may for example determine a gaze point at the display 110 for the eye 150. The gaze tracking system 140 may for example comprise one or more processors or other processing means for determining the gaze direction and/or gaze point of the eye 150.

As shown in FIG. 1, the first axis 102 is transverse to the second axis 103. The first axis 102 is typically orthogonal to the second axis 103. The display 110 and the eye tracking system 140 are arranged at opposite sides of the beam splitter 120. The display 110 provides the display light 101 towards the beam splitter 120 in one direction 102a along the first axis 102 while the light source 141 provides tracking light towards the beam splitter 120 in the opposite direction 102b along the first axis 102. The eye 150 and the mirror 130 are arranged at opposite sides of the beam splitter 120. The eye 150 reflects tracking light 105 back towards the beam splitter 120 in a direction 103b along the second axis 103 while the mirror 130 reflects display light back towards the beam splitter 120 in the opposite direction 103a along the second axis 103.

FIG. 2 shows example light paths for display light 101 in the optical system 100 described above with reference to FIG. 1.

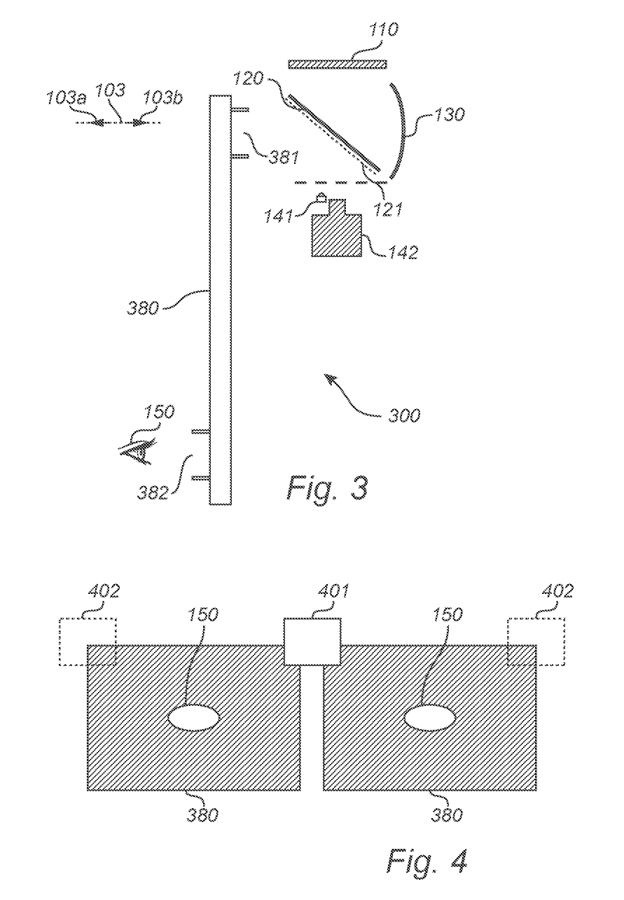

FIG. 3 shows an AR display system 300 including the display system 100 from FIG. 1, but provided with a light guiding optical element 380 (also referred to as a LOE), according to an example. FIG. 3 shows the display system 300 from the side such that the eye 150 of the user is looking towards the right.

The system 300 is provided with a light guiding optical element 380 (e.g., a waveguide) arranged to receive light output by the beam splitter 120 in a direction 103a along the second axis 103 (e.g., the beam splitter 120 may not be arranged in front of the eye 150 (as in FIG. 1)).

The light guiding optical element 380 guides light from the beam splitter 120 towards the eye 150 and guides light reflected at the eye 150 back towards the beam splitter 120. The light guiding optical element 380 is provided with an exit pupil 381 in front of the beam splitter 120, and another exit pupil 382 in front of the eye 150. Light is coupled in and out of the light guiding optical element 380 via the exit pupils 381 and 382. The exit pupil 382 may for example be larger than the exit pupil 381, and pupil splitting may for example be employed in the light guiding optical element 380.

The light guiding optical element 380 may for example be a waveguide using partial reflections, gratings, and/or hologram techniques. The light guiding optical element 380 may for example employ multiple channels for light in different frequency ranges (such as red, blue and green channels for light in the visible spectrum). If tracking light outside the visible spectrum is employed for eye tracking, then the light guiding optical element 380 may for example be provided with one or more extra channels for the tracking light (such as a channel for infrared or near infrared light).

In the display system 300, the eye 150 may for example see the surroundings through the waveguide 380 rather than via the beam splitter 120 and the mirror 130. The eye 150 may therefore receive closer to 100 percent (for example about 70-90 percent) of the light from the surroundings, instead of 25 percent in the system 100 described above with reference to FIG. 1. This also enables use of a reflective (e.g., a totally reflective) mirror as the mirror 130 (e.g., it may not be necessary to use a semitransparent mirror 130 for letting in light from the surroundings). Use of a reflective (e.g., a totally reflective) mirror 130 allows 25 percent of the display light 101 from the display 110 to reach the eye 150 (e.g., compared to approximately 12.5 percent with a semitransparent mirror 130).

FIG. 4 shows a version of the AR display system 300 from FIG. 3, but with light guiding optical elements 380 for the left and right eyes 150, according to an example. FIG. 4 shows the AR system 300 from the front in a direction towards the face of the user. The light guides 380 are arranged in front of the users eyes 150 and allow an AR module 401 (which includes the display 110, the beam splitter 120, the mirror 130, and the eye tracking system 140) to be placed at a different position that in front of each eye 150. The AR module 401 may for example be placed between the eyes 150 as shown in FIG. 4. One AR module 401 with a single display 110, beam splitter 120, mirror 130 and eye tracking system 140 may for example be employed for both eyes 150 (for example in a head up display, HUD). The AR module 401 may comprise separate displays 110, beam splitters 120, mirrors 130, light sources 141, and cameras 142 for each eye 150 (for example in a head mounted device, HMD, using a single waveguide 380 for both eyes 150). Examples may also be envisaged in which separate AR modules 402 are provided for the left and right eyes 150. Such separate AR modules 402 may for example be placed at the side of the respective eye 150 (as shown in FIG. 4) instead of between the eyes 150. As shown in FIG. 3, the AR module 401 (or the AR module 402) and the eye 150 may be located at opposite sides of the light guiding optical elements 380 (in other words, at the right and left sides of the light guiding optical elements 380 in the view shown in FIG. 3). However, examples may also be envisaged where the AR module 402 is located at the same side of the light guiding optical element 380 as the eye 150. The AR module 402 may for example be located at the side of the user's head (for example over the ear).

FIG. 5 shows an AR display system similar to the display system in FIG. 4, but where light sources 503 for the eye tracking are provided along the edge of the light guiding optical elements 380 (e.g., instead of in the AR module 501). The AR module 501 therefore comprises a display 110, a beam splitter 120, a mirror 130, and a camera 142, similarly to the system 100 described above with reference to FIG. 1, but may or may not comprise any light source 141 for providing tracking light. The light sources 503 may for example be directed directly towards the eye 150.

Since light sources 503 mounted at the light guiding optical elements 380 (or mounted at frames around the light guiding optical elements 380) provide tracking light, the tracking light need not pass through the beam splitter 120 and the light guide 380 before reaching the eye 150. This may allow more of the emitted tracking light to reach the eye 150. However, light sources 503 at the light guiding optical elements 380 may be arranged outside (or along the edge) of the field of view of the user so as not to obstruct the users field of view. The eyes 150 are therefore illuminated from the side rather than from the front of the eyes 150. This may cause the illumination of an eye 150 by the light sources 503 to be less efficient than using a light source optically arranged in front of the eye 150 (like the light source 141, described above with reference to FIG. 1). Use of light sources 141 providing tracking light from the front of the eye 150 (as shown in FIG. 1) may provide glints closer to the center of the eye 150, reducing the risk that the glints fall off the cornea, which may affect eye tracking performance.

Examples may also be envisaged in which light sources are arranged at a frame around the beam splitter 120 for providing tracking light for illuminating the eye 150. Example positions 143 for such light sources are shown in FIG. 1. Light sources arranged at the positions 143 may for example be directed directly towards the eye 150. In such examples, the tracking light need not pass through the beam splitter 120 before reaching the eye 150, but like the light sources 503 in FIG. 5, light sources arranged around the beam splitter 120 may illuminate the eye 150 at a larger angle than light sources arranged optically in front of the eye 150 (such as the light source 141 shown in FIG. 1). Small illumination angles may for example improve eye tracking performance.

FIG. 6 shows an AR display system 600 similar to the display system 100 in FIG. 1, but using a polarizing beam splitter 620, according to an example. In contrast to the 50/50 beam splitter 120 in FIG. 1, the polarizing beam splitter 620 is of a type that transmits P state polarized light and reflects S state polarized light. The beam splitter 620 may for example be a cube beam splitter comprising two triangular glass prisms. A polarizing element 601 is arranged between the display 110 and the beam splitter 620 for polarizing the display light into S state linearly polarized display light 602. The polarizing element 601 may for example be a polarizing filter. A polarization-modifying element 603 is arranged between the beam splitter 620 and the mirror 130 for altering a polarization state of display light travelling from the beam splitter 620 to the mirror 130 and back to the beam splitter 620.

The beam splitter 620 is arranged to receive the S state polarized display light 602 and to direct (or output) the S state polarized display light 602 towards the mirror 130 by reflecting the S state polarized display light 602. The polarization-modifying element 603 is a quarter wave-plate (which is often also referred to as a ¼-plate) which first alters a polarization of the display light into circularly polarized light 604 when the light travels to the mirror 130, and then alters a polarization state of the display light into P state linearly polarized light 605 when the light travels back to the beam splitter 620 from the mirror 130. The reflection in the mirror 130 causes the polarization of the circularly polarized light 604 to switch between left and right circular polarization. It will be appreciated that the quarter wave-plate may be arranged at an appropriate orientation (or angle) relative to the polarization of the S state polarized display light 602 for providing the desired change of polarization. The beam splitter 620 is arranged to receive the P state polarized display light 605 returning from the mirror 130, and to direct (or output) the P state polarized display light 605 in a direction 103a along the second axis 103 by transmitting the P state polarized display light 605.

A polarizing element 606 is arranged between the light source 141 and the beam splitter 620 (which is a polarizing beam splitter, PBS). The polarizing element 605 is arranged to polarize tracking light from the light source 141 into S state linearly polarized tracking light 607 before the tracking light from the light source 141 is received by the beam splitter 620. The polarizing element 606 may for example be a polarizing filter.

The beam splitter 620 is arranged to receive the S state linearly polarized tracking light 607 and to direct the S state linearly polarized tracking light 607 in a direction 103a along the second axis 103 by reflecting the S state linearly polarized tracking light 607. The beam splitter 620 is arranged to receive S state polarized tracking light reflected at the eye 150, and to direct (or output) the received reflected S state polarized tracking light along an optical path towards the eye tracking system 140 by reflecting the receive reflected S state polarized tracking light. The camera 142 of the eye tracking system 140 is arranged to receive the received reflected S state polarized tracking light directed by the beam splitter 620.

Less light is lost than in the system 100 described above with reference to FIG. 1 (e.g., due to the use of polarized light and a polarizing beam splitter 620). Little (e.g., none) of the polarized display light and the polarized tracking light may be lost in the polarizing beam splitter 620 (but some light may be lost if polarizing filters are employed to polarize the light).

Half of the display light from the display may for example be lost at the polarizing element 601, and half of the remaining display light may for example be lost due to transmission through the mirror 130, resulting in a remaining portion of 25 percent of the available display light, compared to 12.5 percent for the system 100 in FIG. 1.

Half of the tracking light may be lost at the polarizing element 606, but no tracking light is lost in the beam splitter 620, resulting in a remaining portion of 50 percent of the available tracking light, compared to 25 percent for the system 100 in FIG. 1.

Light reaching the eye 150 from outside the system 600 passes through the mirror 130 and the polarizing beam splitter 620. Half of the light from the surroundings is therefore lost due to reflection in the mirror 130, and half of the remaining light is lost due to reflection in the polarizing beam splitter 620, resulting in a remaining portion of 25 percent of the available light from the surroundings, just like for the system 100 in FIG. 1

It is also possible to employ a light source 141 and/or a display 110 (e.g., in addition to or as an alternative to using polarizing filters 601 and 606), which provides the appropriate polarized light directly, without a subsequent polarizing filter. If the light source 141 and the display 110 provide appropriately polarized light, then losses of light due to subsequent polarization via polarizing filters may be avoided.

Examples may also be envisaged in which the polarizing filters 601 and 606 are dispensed with, and where non-polarized light is provided to the polarizing beam splitter 620. In such examples, the beam splitter 620 may split the display light into S state display light (which is reflected by the beam splitter 620) and P state display light (which is transmitted by the beam splitter 620), and may split the tracking light into S state polarized tracking light (which is reflected by the beam splitter 620) and P state polarized tracking light (which is transmitted by the beam splitter 620). However, use of polarizing filters 601 and 606 may prevent interference caused by display light at the camera 142 and/or tracking light at the display 110.

In some examples, the polarizing beam splitter 620 is frequency-selective. A frequency-selective polarizing beam splitter 620 may for example be obtained by using a polarizing beam splitter 620 comprising a hot mirror 621 (such as a reflector with a band pass filter that transmits light in the range 400 nm-700 nm and reflects light in the rage 800 nm-1000 nm) arranged at the side of the beam splitter 620 at which tracking light is received by the beam splitter 620 (e.g., at the side of the beam splitter 620 facing away from the display 110). The beam splitter 620 then reflects all tracking light from the light source 141 towards the eye 150 (via use of its hot mirror 621), and reflects all received reflected tracking light from the eye 150 towards the camera 142 (via use of the hot mirror 621). Hence, losses of tracking light may be reduced. Further, if such a hot mirror 621 is employed, the polarizing element 606 for polarizing the tracking light may be dispensed with since the frequency-selective polarizing beam splitter 620 reflects the tracking light regardless of the polarization of the tracking light. Using the hot mirror 621 (e.g., instead of the polarizing element 606) may reduce losses of tracking light in the system 600.

In analogy with the systems described above with reference to FIGS. 1-5, the mirror 130 in the system 600 may for example be spherical or aspherical, and the display 110 may for example be arranged at focus of the mirror 130.

In analogy with the systems described above with reference to FIGS. 1-5, the system 600 may for example employ a light guiding optical element to guide light between the eye 150 and the beam splitter 620, and/or the system 600 may for example employ other light sources than the light source 141. For example, the system 600 could employ light sources arranged around a light guiding optical element (e.g., a waveguide), or around the beam splitter 620 such that tracking light need not pass through the beam splitter 620 before reaching the eye 150.

The system 600 may for example comprise further optical elements. The system 600 may for example comprise as a triplet arranged between the display 110 and the beam splitter 620 (for example between the filter 601 and the beam splitter 620) for correcting aberrations.

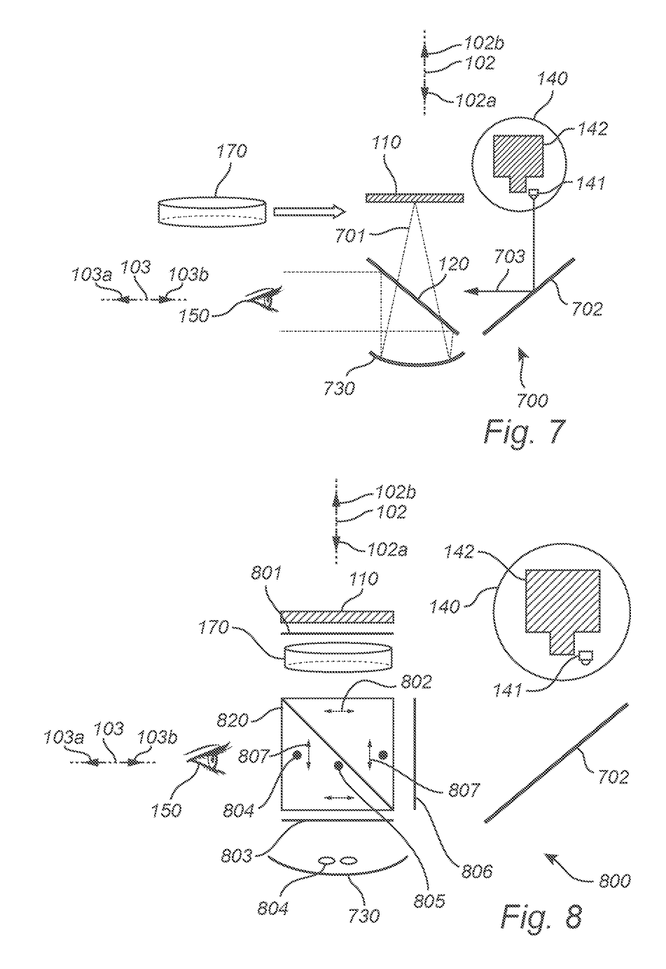

FIG. 7 shows an AR display system 700 according to an example. Similar to the AR display system 100 described above with reference to FIG. 1, the system 700 comprises a display 110, a beam splitter 120, a mirror 730 and an eye tracking system 140, and all these components may be of the same type as corresponding components in the system 100. However, in the present example, the mirror 730 need not be semitransparent (the semitransparent mirror 130 in FIG. 1 may be semitransparent), since the eye 150 does not need to look through the mirror 730 for seeing the surroundings. Hence, the mirror 730 is reflective (e.g., totally reflective).

A difference compared to the system 100 in FIG. 1 is that the display light 701 from a display 110 in the system 700 reaches an eye 150 via transmission through the beam splitter 120 followed by reflection in the mirror 730, and then reflection in the beam splitter 120. Another difference is that the eye tracking is performed via transmission of the eye tracking light 703 through the beam splitter 120.

More specifically, the beam splitter 120 is arranged to receive display light 701 from the display 110 in a direction 102a along a first axis 102 and to direct (e.g., output) half of the display light 701 from the display 110 towards the mirror 730 by transmitting half of the display light 701. The mirror 730 is arranged to reflect the display light from the beam splitter 120 back towards the beam splitter 120. The beam splitter 120 is arranged to receive reflected display light from the mirror 730 and to output half of the received reflected display light from the mirror 730 in a direction 103a along a second axis 103. The eye tracking system 140 comprises a light source 141 arranged to provide tracking light 703 for reflection at an eye 150. The beam splitter 120 is arranged to receive tracking light 703 from the eye tracking system 140 and to direct (e.g., output) half of the tracking light 703 from the eye tracking system 140 in a direction 103a along the second axis 103 by transmitting half of the tracking light 103 from the eye tracking system 140. The beam splitter 120 is arranged to receive reflected tracking light from a direction 103b back along the second axis 103 and to direct (e.g., output) half of the received reflected tracking light along an optical path towards the eye tracking system 140. The eye tracking system 140 comprises a camera 142 arranged to receive at least some of the received reflected tracking light directed by the beam splitter 120.

The optical system 700 is an AR system where the eye 150 watches the surroundings through the beam splitter 120. The eye tracking system 140 is placed out of view of the eye 150. In the present example, the system 700 comprises a second mirror 702. The beam splitter 120 is arranged to receive tracking light 703 from the eye tracking system 140 via reflection in the second mirror 702. The camera 142 is arranged to receive received reflected tracking light directed by the beam splitter 120 via reflection in the second mirror 702.

The second mirror 702 is semitransparent and arranged to allow at least some light from outside the display system 700 to pass through the second mirror 702 towards the beam splitter 120. In the present example, the second mirror 702 is arranged to transmit light in the visual range and to reflect light outside the visual range (such as the infrared or near infrared range employed by the light source 141). Hence, visible light from the surroundings may enter the optical system 700 through the second mirror 702, and display light reflected by the beam splitter 120 exits the display system 700 through the second mirror 702 without causing interference at the camera 142. The second mirror 702 may for example be a so-called hot mirror or a notch filter that only reflects light at a specific wavelength (such as 850 nm tracking light, to avoid unwanted IR light from the surroundings environment).

Since a 50/50 beam splitter 120 is employed, some light from the display 110, the light source 141 and the surroundings does not reach the eye 150, and some light reflected at the eye 150 does not reach the camera 142.

Light from the surroundings reaches the eye 150 via transmission through the second mirror 702 (with little or no loss of light since it is only reflective for infrared or near infrared light) and the beam splitter 120, so about 50 percent of the available light from the surroundings may reach the eye 150.

Display light 701 from the display 110 reaches the eye 150 via transmission through the beam splitter 120, followed by reflection in the mirror 730 (with little or no loss of light since it is reflective (e.g., totally reflective)), and then reflection at the beam splitter 120, so about 25 percent of the available display light 701 from the display 110 may reach the eye 150.

Tracking light 703 from the light source 142 reaches the eye 150 via reflection in the second mirror 702 (with little or no loss of light since the second mirror 702 is a hot mirror) and transmission through the beam splitter 120. Tracking light reflected at the eye 150 reaches the camera 142 via transmission through the beam splitter 120 and reflection in the second mirror 702 (with little or no loss of light since the second mirror 702 is a hot mirror). Hence, about 25 percent of the available tracking light may reach the camera 142. Since not all light is typically reflected at the eye, less than 25 percent of the tracking light 107 from the light source 141 may reach the camera 142.

The mirror 730 is concave and may for example be spherical or aspherical. The display 110 may for example be arranged at focus of the mirror 730.

In analogy with the systems described above with reference to FIGS. 1-5, the system 700 may for example employ a light guiding optical element to guide light between the eye 150 and the beam splitter 120, and/or the system 700 may for example employ other light sources than the light source 141. For example, the system 700 could employ light sources arranged around a light guiding optical element (e.g., a waveguide), or around the beam splitter 120 such that tracking light need not pass through the beam splitter 120 before reaching the eye 150.

The system 700 may for example comprise further optical elements. The system 700 may for example comprise as a triplet 170 arranged between the display 110 and the beam splitter 120.

Examples may also be envisaged in which the proportion of light transmitted and reflected by the beam splitter 120 in the system 700 is different than 50/50. The proportion of light transmitted and reflected by the beam splitter 120 in the system 700 may be any number including 10/90, 20/80, 30/70, 40/60, 50/50, 60/40, 70/30, 80/20, 90/10.

FIG. 8 shows an AR display system 800 similar to the AR display system in FIG. 7, but using a polarizing beam splitter 820, according to an example. In contrast to the 50/50 beam splitter 120 in FIG. 7, the polarizing beam splitter 820 is of a type that transmits P state polarized light and reflects S state polarized light, just like the polarized beam splitter 620 described above with reference to FIG. 6. A polarizing element 801 is arranged between the display 110 and the beam splitter 820 for polarizing the display light into P state linearly polarized display light 802. A polarization-modifying element 803 is arranged between the beam splitter 820 and the mirror 730 for altering a polarization state of display light travelling from the beam splitter 820 to the mirror 730 and back to the beam splitter 820.

The beam splitter 820 is arranged to receive the P state polarized display light 802 and to direct (or output) the P state polarized display light 802 towards the mirror 730 by transmitting the P state polarized display light 802. The polarization-modifying element 803 is a quarter wave-plate (which may also be referred to as a [symbol] 4-plate) which first alters a polarization of the display light into circularly polarized light 804 when the light travels to the mirror 730, and then alters a polarization state of the light into S state linearly polarized display light 805 when the light travels back to the beam splitter 820 from the mirror 730. The reflection in the mirror 730 causes the polarization of the circularly polarized light 804 to switch between left and right circular polarization. It will be appreciated that the quarter wave-plate 803 should be arranged at an appropriate orientation (or angle) relative to the polarization of the P state polarized display light 802 for providing the desired change of polarization. The beam splitter 820 is arranged to receive the S state polarized display light 805 returning from the mirror 730, and to direct (or output) the S state polarized display light 805 in a direction 103a along the second axis 103 by reflecting the S state polarized display light 805.

A polarizing element 806 is arranged between the light source 141 and the beam splitter 620. The polarizing element 805 is arranged to polarize tracking light from the light source 141 into P state linearly polarized tracking light 807 before the tracking light from the light source 141 is received by the beam splitter 820. The polarizing element 806 may for example be a polarizing filter. The polarizing element 806 may for example block some unwanted surrounding light in the infrared or near infrared range by acting as sun glasses.

The beam splitter 820 is arranged to receive the P state linearly polarized tracking light 806 and to direct the P state linearly polarized tracking light 806 in a direction 103a along the second axis 103 by transmitting the P state linearly polarized tracking light 806. The beam splitter 820 is arranged to receive P state linearly polarized tracking light reflected at the eye 150, and to direct (e.g., output) the received reflected P state linearly polarized tracking light along an optical path towards the eye tracking system 140 by transmitting the receive reflected P state tracking light. The camera 142 of the eye tracking system 140 is arranged to receive the received reflected P state tracking light directed by the beam splitter 820.

Less light is lost than in the system 700 described above with reference to FIG. 7 (e.g., due to the use of polarized light and a polarizing beam splitter 820). Little or none of the polarized display light and the polarized tracking light may be lost in the polarizing beam splitter 820.

Half of the display light from the display 110 may for example be lost at the polarizing element 801, resulting in a remaining portion of 50 percent of the available display light, compared to 25 percent for the system 700 in FIG. 7.

Half of the tracking light may be lost at the polarizing element 806, but little or no tracking light is lost in the beam splitter 820, resulting in a remaining portion of 50 percent of the available tracking light, compared to 25 percent display light for the system 700 in FIG. 7.

Light reaching the eye from outside the system 700 passes through the second mirror 702 (allows light in the visible range to pass through), the polarizing element 806, and the polarizing beam splitter 820 (no loss of polarized light), resulting in a remaining portion of 50 percent of the available light from the surroundings, as for the system 700 in FIG. 7.

It is also possible to employ a light source 141 and/or a display 110 (e.g., in addition to or as an alternative to using polarizing filters 801 and 806), which provides the appropriate polarized light directly, without a subsequent polarizing filters. If the light source 141 and the display 110 provide appropriately polarized light, then losses of light due to subsequent polarization via polarizing filters may be avoided.

Examples may also be envisaged in which the polarizing filters 801 and 806 are dispensed with, and where non-polarized light is provided to the polarizing beam splitter 820. In such examples, the beam splitter 820 may split the display light into S state display light (which is reflected by the beam splitter 820) and P display light (which is transmitted by the beam splitter 820), and may split the tracking light into S state polarized tracking light (which is reflected by the beam splitter 820) and P state polarized tracking light (which is transmitted by the beam splitter 820). However, use of polarizing filters 801 and 806 may prevent interference caused by display light at the camera 142 and/or tracking light at the display 110.

In analogy with the systems described above with reference to FIGS. 1-5, the system 800 may for example employ a light guiding optical element to guide light between the eye 150 and the beam splitter 820, and/or the system 800 may for example employ other light sources than the light source 141. For example, the system 800 could employ light sources arranged around a light guiding optical element (or waveguide), or around the beam splitter 820 such that tracking light need not pass through the beam splitter 820 before reaching the eye 150.

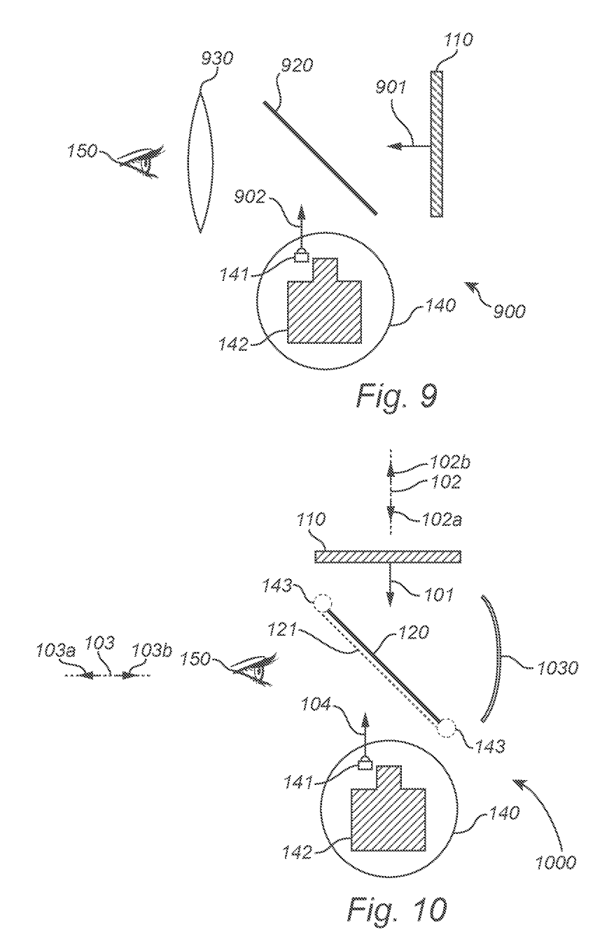

FIG. 9 shows an example virtual reality (VR) display system 900 with eye tracking. The system 900 comprises a display 110, a hot mirror 920, a lens 930, and an eye tracking system 140. The display 110 displays an image. Display light 901 from the display 110 is transmitted through the hit mirror 920 towards an eye 150. The lens 930 is arranged along the optical path between the hot mirror 920 and the eye 150 to gather the display light for providing a virtual reality experience with large field of view. The lens 930 may for example be a convex lens. A light source 141 of the eye tracking system 140 emits tracking light 902. Tracking light 902 from the light source 141 is reflected by the hot mirror 920 towards the eye 150. Tracking light which has been reflected at the eye 150 is then received by the hot mirror 920, and the received reflected tracking light is reflected by the hot mirror 920 towards a camera 142 of the eye tracking system 140.

Since the lens 930 is arranged in the optical path between the eye 150 and the hot mirror 920, tracking light which has been reflected at the eye 150 will pass through the lens 930 before reaching the camera 142. If sufficiently reliable eye tracking performance is to be obtained, then distortion and/or other optical effects caused by the lens 930 may be considered when performing the eye tracking.

FIG. 10 shows a VR display system 1000 similar to the AR display system 100 in FIG. 1, according to an example. A difference between the VR system 1000 in FIG. 10 and the AR system 100 described above with reference to FIG. 1 is that the mirror 1030 in the VR system 1000 need not be semitransparent (the mirror 130 in the AR system 100 may be semitransparent where the eye 130 looks through the mirror 130 to see the surroundings).

The beam splitter 120 directs half of the display light 101 received from the display 110 towards the mirror 1030 by reflecting half of the display light 101. The mirror 1030 reflects the display light from the beam splitter 120 back towards the beam splitter 120. The beam splitter 120 directs half of the reflected display light from the mirror 1030 in a direction 103a along the second axis 103 by transmitting reflected display light. The beam splitter 120 receives tracking light 104 from a light source 141 of an eye tracking system 140, and directs half of the tracking light 104 in in a direction 103a along the second axis 103 by reflecting half of the tracking light 104. The beam splitter 120 receives tracking light that has been reflected at the eye 150, and directs half of the received reflect tracking light along an optical path towards the camera 142 of the eye tracking system by reflecting half of the received reflected tracking light. The camera 142 receives the received reflected tracking light directed by the beam splitter 120.

The mirror 1030 may be concave, and may be spherical or aspherical (for example parabolic). The display 110 may for example be positioner at the focus of the mirror 1030 for achieving a virtual image of the image displayed at the display 110.

In analogy with the systems described above with reference to FIGS. 1-5, the system 1000 may for example employ other light sources than the light source 141. For example, the system 1000 could employ light sources arranged around the beam splitter 120 such that tracking light need not pass through the beam splitter 120 before reaching the eye 150. Such example positions 143 around the beam splitter 120 are indicated in FIG. 10. Light sources arranged around the beam splitter 120 may for example be directed directly towards the eye 150.

The system 1000 may for example comprise further optical elements. The system 1000 may for example comprise as a triplet arranged between the display 110 and the beam splitter 120.

Examples may also be envisaged in which the proportion of light transmitted and reflected by the beam splitter 120 in the system 1000 is different than 50/50. The proportion of light transmitted and reflected by the beam splitter 120 in the system 1000 may be any number including 10/90, 20/80, 30/70, 40/60, 50/50, 60/40, 70/30, 80/20, 90/10.

The beam splitter 120 may for example be spectrally selective (e.g., frequency-dependent). The beam splitter 120 in FIG. 10 may comprise a hot mirror 121 in analogy with the beam splitter 120 in FIG. 1.

Examples may also be envisaged in which the beam splitter 120 in the system 1000 is replaced by a polarizing beam splitter 620 of the type described above with reference to FIG. 6, and a polarization-modifying element (analogous to the polarization-modifying element 603 in FIG. 6) may be arranged between the polarizing beam splitter and the mirror 1030 for altering a polarization state of display light travelling from the polarizing beam splitter to the mirror 1030 and back to the polarizing beam splitter. In analogy with the system 600 in FIG. 6, light from the display 110 and the light source 141 may for example be provided with suitable polarizations (the light source may for example be a VCSEL providing linearly polarized light), or polarizing elements (analogous to the polarizing elements 601 and 606) may for example be provided for polarizing light from the display 110 and the light source 141. Use of a polarized beam splitter may decrease the amount of light lost in the display system 1000.

The VR system 1000 in FIG. 10 may not include a lens 930 between the eye and the beam splitter 120 (e.g., the VR system 900 in FIG. 9 may include such a lens). Undesirable optical effects (or distortion) caused by the lens 930 to tracking light may therefore be avoided, which may facilitate eye tracking and/or may improve the reliability of the eye tracking.

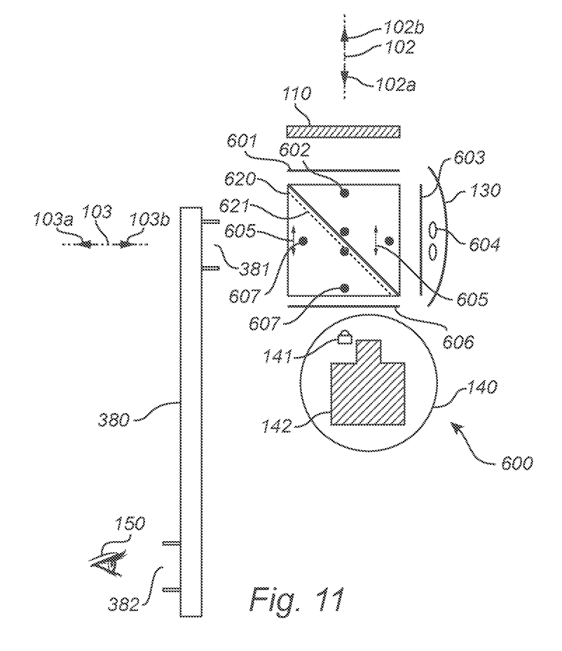

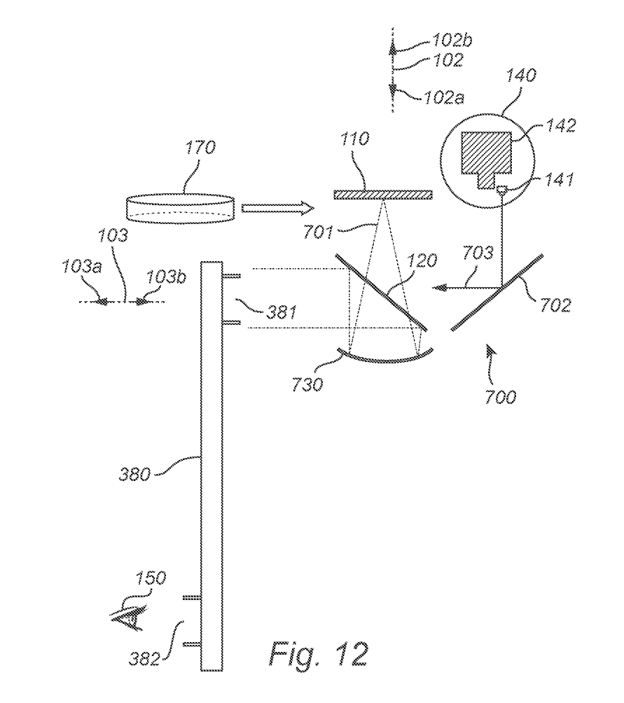

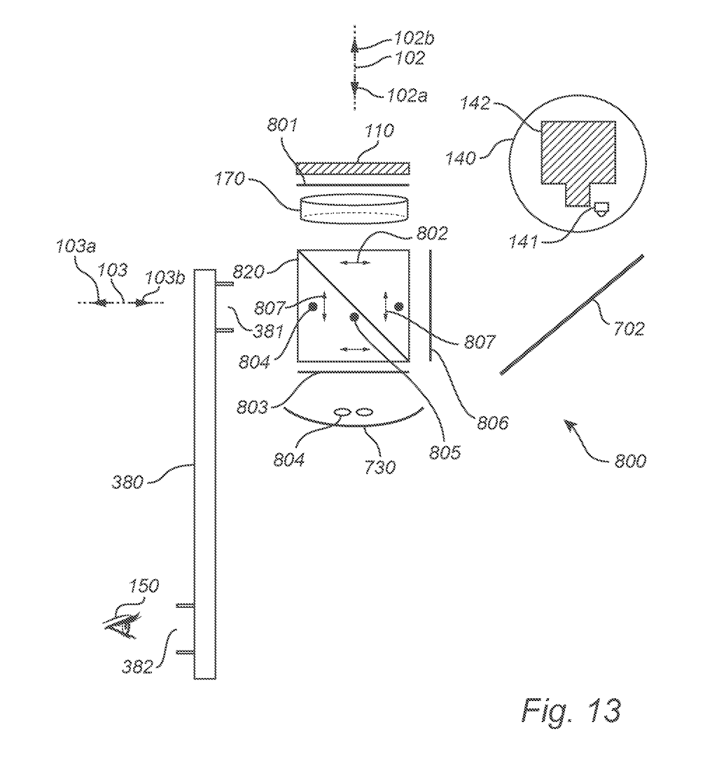

The person skilled in the art realizes that the present invention is by no means limited to the example described above. On the contrary, many modifications and variations are possible within the scope of the appended claims. For example, it will be appreciated that the systems 600, 700 and 800 described with reference to FIGS. 6-8 may be modified to employ waveguides in analogy with how the system 100 from FIG. 1 can be modified to employ one or more waveguides 380, as described with reference to FIGS. 3-5. This is illustrated in FIGS. 11-13, respectively. For example, a waveguide 380 may be arranged for guiding light between the eye 150 and the beam splitter 620 in the system 600 (as shown in FIG. 11), or for guiding light between the eye 150 and the beam splitter 120 in the system 700 (as shown in FIG. 12), or for guiding light between the eye 150 and the beam splitter 820 in the system 800 (as shown in FIG. 13). If a waveguide 380 is arranged for guiding light between the eye 150 and the beam splitter 620 in the system 600, then the eye 150 may for example see the surroundings through the waveguide 380, so the mirror 130 need not be semitransparent. By using a totally reflecting mirror 130 in the system 600 (and a waveguide 380 as shown in FIG. 11), more of the light from the display 110 may reach the eye 150 than if a semitransparent mirror 130 were to be used.

Additionally, variations to the disclosed examples can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

What is claimed:

1. A display system, comprising:
a display arranged to display an image;
a beam splitter;
a mirror; and
an eye tracking system, wherein the beam splitter is arranged to receive display light from the display in a first direction and to direct at least some of the display light from the display towards the mirror, wherein the mirror is arranged to reflect at least some of the display light from the beam splitter back towards the beam splitter, wherein the beam splitter is arranged to receive at least some of the reflected display light from the mirror and to direct at least some of the reflected display light from the mirror in a second direction, wherein the eye tracking system comprises a light source arranged to provide tracking light for reflection at an eye, wherein the beam splitter is arranged to receive reflected tracking light back from the second direction and to direct at least some of the received reflected tracking light along an optical path towards the eye tracking system, and wherein the eye tracking system comprises a camera arranged to receive at least some of the received reflected tracking light directed by the beam splitter.

2. The display system of claim 1, wherein the beam splitter is a polarizing beam splitter, and wherein the display system further comprises a polarization-modifying element arranged between the beam splitter and the mirror for altering a polarization state of display light travelling from the beam splitter to the mirror and back to the beam splitter.

3. The display system of claim 2, wherein the polarization-modifying element comprises a quarter wave-plate.

4. The display system of claim 2, wherein:
the display is arranged to display the image using polarized display light; or
the display system comprises a first polarizing element arranged to polarize display light from the display before the display light from the display is received by the beam splitter.

5. The display system of claim 2, wherein:
the light source is arranged to output polarized tracking light; or
the display system comprises a second polarizing element arranged to polarize tracking light from the light source before the tracking light from the light source is received by the beam splitter.

6. The display system of claim 1, wherein the beam splitter is arranged to receive tracking light from the eye tracking system and to direct at least some of the tracking light from the eye tracking system in the second direction.

7. The display system of claim 6, wherein the eye tracking system is arranged to provide the tracking light such that it is received by the beam splitter along an axis, and wherein the camera is arranged to receive light directed by the beam splitter back along the axis.

8. The display system of claim 1, wherein the beam splitter is arranged to direct the at least some of the display light from the display towards the mirror by reflecting display light from the display, wherein the beam splitter is arranged to direct the at least some of the reflected display light from the mirror in the second direction by transmitting reflected display light from the mirror, and wherein the beam splitter is arranged to direct the at least some of the received reflected tracking light by reflecting at least some of the received reflected tracking light.

9. The display system of claim 8, wherein the mirror is semitransparent and arranged to allow at least some light from outside the display system to pass through the mirror towards the beam splitter.

10. The display system of claim 8, wherein the beam splitter is arranged to receive tracking light from the eye tracking system and to direct at least some of the tracking light from the eye tracking system in the second direction by reflecting tracking light from the eye tracking system.

11. The display system of claim 8, comprising a spectrally selective filter arranged between the eye tracking system and the beam splitter for preventing display light from the display to reach the camera.

12. The display system of claim 8, wherein the beam splitter is spectrally selective.

13. The display system of claim 12, wherein the beam splitter is arranged to act as a reflector for light in a first frequency range, and wherein the beam splitter is arranged to split light in a second frequency range into a transmitted portion and a reflected portion.

14. The display system of claim 1, wherein the beam splitter is arranged to direct the at least some of the display light from the display towards the mirror by transmitting display light from the display, wherein the beam splitter is arranged to direct the at least some of the reflected display light from the mirror in the second direction by reflecting reflected display light from the mirror, and wherein the beam splitter is arranged to direct the at least some of the received reflected tracking light by transmitting at least some of the received reflected tracking light.

15. The display system of claim 14, further comprising a second mirror, wherein the camera is arranged to receive, via reflection in the second mirror, at least some of the received reflected tracking light directed by the beam splitter.

16. The display system of claim 15, wherein the second mirror is semitransparent and arranged to allow at least some light from outside the display system to pass through the second mirror towards the beam splitter.

17. The display system of claim 15, wherein the second mirror is arranged to transmit light in the visual range and to reflect light in the infrared or near infrared range.

18. The display system of claim 15, wherein the beam splitter is arranged to receive tracking light from the eye tracking system and to direct at least some of the tracking light from the eye tracking system in the second direction by transmitting tracking light from the eye tracking system.

19. The display system of claim 18, wherein the beam splitter is arranged to receive tracking light from the eye tracking system via reflection in the second mirror.

20. The display system of claim 1, further comprising a light guiding optical element arranged to receive light directed by the beam splitter in the second direction, wherein the light guiding optical element is arranged to guide at least some light from the beam splitter towards the eye and to guide at least some light reflected at the eye towards the beam splitter.

21. The display system of claim 1, further comprising one or more optical elements arranged between the display and the beam splitter for correcting aberrations.

22. The display system of claim 21, wherein the one or more optical elements include a triplet.

23. The display system of claim 1, wherein the mirror is concave.

24. The display system of claim 23, wherein the mirror is a spherical mirror or an aspherical mirror.

25. The display system of claim 1, wherein the light source is arranged to output tracking light in the infrared or near infrared range.

26. The display system of claim 1, wherein the display system is configured to be included in a head mounted device (HMD) or a head up display (HUD).
